(19) United States
(12) Patent Application Publication
(10) Pub. No.: US 2026/0087697 A1
(43) Pub. Date: Mar. 26, 2026

(54) LOCATION DETERMINATION FOR OBJECT INSERTION INTO A SCENE

(71) Applicant: QUALCOMM Incorporated, San Diego, CA (US)

(72) Inventors: Davide ABATI, Amsterdam (NL); Jens PETERSEN, Amsterdam (NL); Mohamed OMRAN, Amsterdam (NL); Auke Joris WIGGERS, Amsterdam (NL); Amirhossein HABIBIAN, Amsterdam (NL)

(21) Appl. No.: 18/891,964

(22) Filed: Sep. 20, 2024

(51) Int. Cl. G06T 11/60; G06V 10/774

(52) U.S. Cl. CPC G06T 11/60; G06V 10/774; G06T 2210/12

(57) ABSTRACT

A device includes a memory configured to store an image of a scene. The device also includes one or more processors coupled to the memory. To determine the location of one or more objects to be generated in the image, the one or more processors are configured to obtain the image of the scene, obtain an indication of a designated class of object to insert into the scene, and process the image to determine, based on the designated class and scene features of the scene, a bounding box location and bounding box dimensions for insertion of an object having the designated class into the scene. The one or more processors are also configured to output the bounding box location and the bounding box dimensions.

### I. FIELD

The present disclosure is generally related to image processing.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to generate image data. For example, generative data augmentation (GDA) (e.g., generating synthetic data to extend the training set of a learning model) is re-gaining popularity as generative models advance. Possible applications include data generation for automotive perception, where edge case scenarios are potentially safety-critical and costly to acquire. Typically, cut-and-paste image generation approaches generate a pool of images, which are pasted into real or synthetic backgrounds. The resulting images do not look realistic, as foreground objects can blend poorly with the background or appear out of context.

### III. SUMMARY

According to aspects disclosed herein, a device includes a memory configured to store an image of a scene. The device also includes one or more processors coupled to the memory. To determine the location of one or more objects to be generated in the image, the one or more processors are configured to obtain the image of the scene, obtain an indication of a designated class of object to insert into the scene, and process the image to determine, based on the designated class and scene features of the scene, a bounding box location and bounding box dimensions for insertion of an object having the designated class into the scene. The one or more processors are also configured to output the bounding box location and the bounding box dimensions.

According to aspects disclosed herein, a method of determining the location of one or more objects to be generated in an image includes obtaining, at a device, an image of a scene. The method includes obtaining, at the device, an indication of a designated class of object to insert into the scene. The method includes processing, at the device, the image to determine, based on the designated class and scene features of the scene, a bounding box location and bounding box dimensions for insertion of an object having the designated class into the scene. The method also includes outputting, at the device, the bounding box location and the bounding box dimensions.

According to aspects disclosed herein, a non-transitory computer-readable medium stores instructions that, when executed by one or more processors to determine the location of one or more objects to be generated in an image, cause the one or more processors to obtain an image of a scene and to obtain an indication of a designated class of object to insert into the scene. The instructions, when executed by one or more processors, cause the one or more processors to process the image to determine, based on the designated class and scene features of the scene, a bounding box location and bounding box dimensions for insertion of an object having the designated class into the scene. The instructions, when executed by one or more processors, also cause the one or more processors to output the bounding box location and the bounding box dimensions.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram illustrating an example of a system operable to determine a location for object insertion into a scene, in accordance with some examples of the present disclosure.

FIG. 2 is a block diagram illustrating an example of components and operations that can be implemented in the system of FIG. 1, in accordance with some examples of the present disclosure.

FIG. 3 is a flow diagram illustrating an example of operations that can be performed by the system of FIG. 1, in accordance with some examples of the present disclosure.

FIG. 4 is a block diagram illustrating an example of components and operations that can be implemented in the system of FIG. 1, in accordance with some examples of the present disclosure.

FIG. 5 is a block diagram illustrating an example of components and operations that can be implemented in the system of FIG. 1, in accordance with some examples of the present disclosure.

FIG. 6 is a flow diagram illustrating an example of operations that can be performed by the system of FIG. 1, in accordance with some examples of the present disclosure.

FIG. 7 is a diagram illustrating an example of an integrated circuit operable to determine a location for object insertion into a scene, in accordance with some examples of the present disclosure.

FIG. 8 is a diagram of an example of a portable electronic device operable to determine a location for object insertion into a scene, in accordance with some examples of the present disclosure.

FIG. 9 is a diagram of an example of a camera operable to determine a location for object insertion into a scene, in accordance with some examples of the present disclosure.

FIG. 10 is a diagram of an example of a wearable electronic device operable to determine a location for object insertion into a scene, in accordance with some examples of the present disclosure.

FIG. 11 is a diagram of an example of an extended reality device, such as augmented reality glasses, operable to determine a location for object insertion into a scene, in accordance with some examples of the present disclosure.

FIG. 12 is a diagram of an example of a headset, such as a virtual reality, mixed reality, or augmented reality headset, operable to determine a location for object insertion into a scene, in accordance with some examples of the present disclosure.

FIG. 13 is a diagram of an example of a voice-controlled speaker system operable to determine a location for object insertion into a scene, in accordance with some examples of the present disclosure.

FIG. 14 is a diagram of a first example of a vehicle operable to determine a location for object insertion into a scene, in accordance with some examples of the present disclosure.

FIG. 15 is a diagram of a second example of a vehicle operable to determine a location for object insertion into a scene, in accordance with some examples of the present disclosure.

FIG. 16 is a diagram of a particular example of a method of determining a location for object insertion into a scene, in accordance with some examples of the present disclosure.

FIG. 17 is a block diagram of a particular illustrative example of a device that is operable to determine a location for object insertion into a scene, in accordance with some examples of the present disclosure.

### V. DETAILED DESCRIPTION

Systems and methods to determine a location for object insertion into a scene are disclosed. Conventional augmented image generation techniques, such as cut-and-paste approaches, typically do not look realistic, as foreground objects blend poorly with the background or appear out of context.

In the disclosed techniques, an object location model determines the location of one or more objects to be generated in an image of a scene based on the designated classes of the one or more objects and further based on features of the scene. By determining locations to insert the one or more objects based on the features of the scene, the object location model enables insertion of instances of objects of various classes into scenes in more natural and realistic manner for the particular context of the scene.

According to some aspects, the object locations are determined using a factorized probabilistic location modeling technique that extracts scene semantics of the scene and determines plausible locations for object insertion based on statistical data from a dataset of scenes. For example, the dataset of scenes can be parsed to extract scene depths, detect objects in the scenes, and collect data including an object class and data corresponding to the depth, location, and dimensions of a bounding box for each of the detected objects. Various distributions may be generated associated with the collected data, and one or more such distributions can be sampled by the object location model to determine one or more of a depth, a location, and dimensions of a bounding box for insertion of an instance of an object into a scene. According to an aspect, one or more of the depth, location, and dimensions of the bounding box are further based on a depth map and semantics of the scene. For example, the object location model may ensure that a location for insertion of a car into a scene is constrained to areas of the scene that correspond to drivable surfaces.

According to some aspects, the object locations are determined using a trained object location model. In an example, the object location model is trained to process a scene and to predict one or more bounding boxes, of a set of candidate bounding boxes, that are the most plausible locations for an object of a designated class based on features of the scene. The object location model can be trained by masking one or more objects in a set of training images in addition to generating multiple additional distractor masks, and iteratively updating parameters of the object location model to improve the ability of the model to correctly predict which of the masked areas in the training areas are the locations of the masked objects. Once trained, during inference a novel scene with multiple masks corresponding to various candidate boxes may be input to the object location model, and the object location model can generate a prediction of which of the masks correspond to plausible locations of an object having a designated class.

By determining object locations based on a designated object class and scene features of the scene, the disclosed techniques enable objects to be inserted into the scene at sensible and natural locations in the context of the scene. Thus, the present techniques provide the advantage of enabling more realistic synthesized images to be generated as compared to conventional techniques. Because inpainting techniques, such as using latent diffusion models, are sensitive to location, using the more realistic locations identified by the disclosed techniques enables higher quality images to be generated using such object inpainting techniques. Higher quality images provide the advantage of improving a user experience and reducing an image editing time in embodiments in which the disclosed techniques are used in conjunction with an interactive image editing application, such as at a mobile device.

In applications such as generative data augmentation in which the object insertion is used to generate synthetic training images having relatively rare object occurrences to augment a set of training images, positioning inserted objects at more realistic locations, and with higher quality, results in more effective training of models such as object detection models. For example, an object detector trained using an augmented training set that is generated using the disclosed techniques has been shown to outperform instances of the object detector that are trained using an augmented data set that is generated using conventional object placement strategies. Thus, the performance of a device implementing one or more of the disclosed techniques is improved.

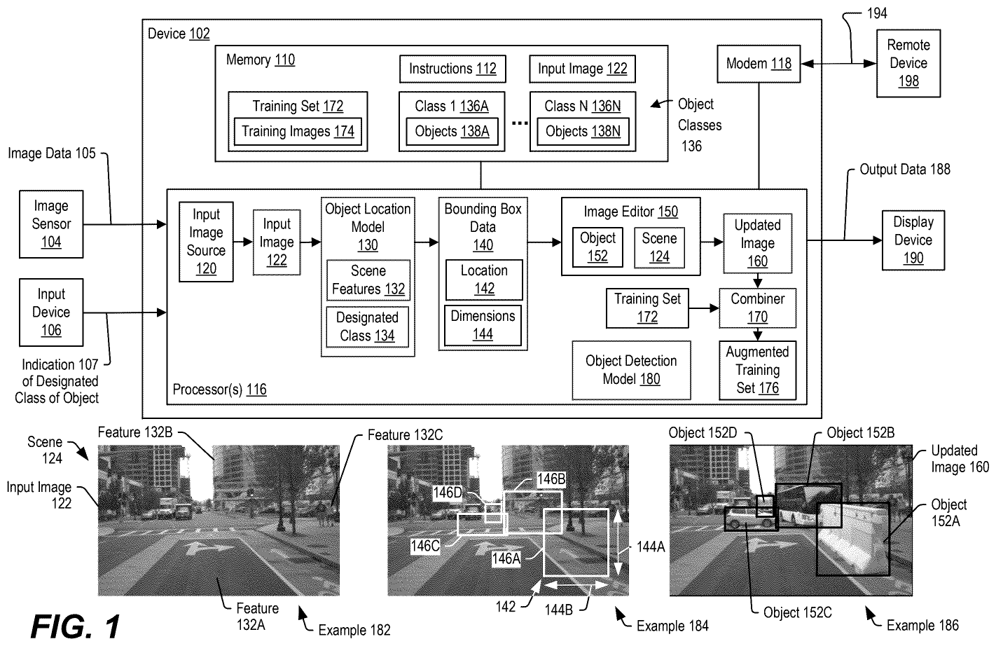

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 116 of FIG. 1), which indicates that in some implementations the device 102 includes a single processor 116 and in other implementations the device 102 includes multiple processors 116. For ease of reference herein, such features are generally introduced as “one or more” features and are subsequently referred to in the singular or optional plural (as indicated by “(s)” in the name of the feature) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein, e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple bounding boxes 146 are illustrated and associated with reference numbers 146A, 146B 146C, and 146D. When referring to a particular one of these patches, such as a bounding box 146A, the distinguishing letter “A” is used. However, when referring to any arbitrary one of these bounding boxes or to these bounding boxes as a group, the reference number 146 is used without a distinguishing letter.

As used herein, the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, retrieving, receiving, or accessing the parameter (or signal) that is already generated, such as by another component or device.

As used herein, an ‘image’ (or equivalently, a ‘frame’) is a visual representation of a scene or object, which may be captured by a camera or generated digitally. An image typically includes a two-dimensional array of pixels, with each pixel having a specific color value, intensity, and spatial location. Images can convey various information, such as texture, shape, color, and context; however, images do not explicitly identify semantic meaning. As used herein, a ‘semantic’ map, also known as a segmentation map, is a processed representation of an image that assigns a label or category to each pixel, based on its visual content. Such labels represent the semantic meaning or class of the object, region, or feature present at that pixel location. Semantic maps are a form of image segmentation, where each pixel is assigned a class from a predefined set of classes (e.g., road, building, sky, tree, car, person, etc.).

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a particular illustrative example of a system 100 is depicted that includes a device 102 that is configured to determine a location for object insertion into a scene. For example, the device 102 is configured to process an image of a scene, such as an input image 122 of a scene 124, using an object location model 130 that determines, based on features within the scene 124 and a designated object class, the location and dimensions of a bounding box for insertion of an instance of the designated object class into the scene 124. Determining the bounding box based on the designated object class and the scene features enables the device 102 to add an object into the scene 124 in more realistic locations and having more realistic sizing, in the context of the scene, as compared to conventional techniques.

Optionally, the device 102 includes, or is coupled to, one or more image sensors 104. The image sensor 104 is configured to generate image data 105 that, in some embodiments, corresponds to the input image 122. In a particular embodiment, the image sensor 104 corresponds to or is incorporated into a camera, such as a still image camera, a video camera, a stereo camera, a thermal imaging camera, one or more other types of camera, or a combination thereof. According to an aspect, the image data 105 includes data (e.g., pixel values) of individual images, video data, or a combination thereof.

The device 102 includes a memory 110 coupled to a processor 116 and configured to store instructions 112 and the input image 122, such as individual images or data corresponding to images included in video data (e.g., video frames). The memory 110 may also store data (e.g., parameters, such as weights and biases) associated with one or more models, such as the object location model 130, that may be implemented at the processor 116. In a particular implementation, the memory 110 corresponds to a dynamic random access memory (DRAM) of a double data rate (DDR) memory subsystem.

The processor 116 includes an input image source 120 and the object location model 130, and optionally includes an image editor 150, a combiner 170, an object detection model 180, or a combination thereof. According to some embodiments, the processor 116 is configured to execute the instructions 112 to perform operations associated with the object location model 130, the image editor 150, the combiner 170, and the object detection model 180. In various aspects, some or all of the functionality associated with the object location model 130, the image editor 150, the combiner 170, the object detection model 180, or a combination thereof, is performed via execution of the instructions 112 by the processor 116, performed by processing circuitry of the processor 116 in a hardware implementation, or a combination thereof.

The input image source 120 is coupled to the object location model 130 and configured to provide the input image 122 for processing by the object location model 130. For example, the input image source 120 may correspond to the image sensor 104, a portion of one or more of media files (e.g., a media file including the input image 122 that is retrieved from the memory 110), one or more other sources of input images, such as from a game engine, an extended reality (XR) engine (e.g., a virtual reality (VR) engine, an augmented reality (AR) engine, or a mixed reality (MR) engine), a remote media server, or a combination thereof.

The object location model 130 is configured to obtain the input image 122 of the scene 124 and to obtain an indication 107 of a designated class 134 of object to insert into the scene 124. To illustrate, the device 102 optionally includes, or is coupled to, an input device 106, such as a user interface (e.g., a keyboard, touchscreen, speech interface, etc.), that is configured to generate the indication 107 in response to receiving user input regarding the designated class 134. In some embodiments, the indication 107 of the designated class 134 may instead be received from a remote source (e.g., via the modem 118) or generated by the processor 116 (e.g., during execution of an XR engine or an application to generate an augmented training set 176 for training of the object detection model 180 as illustrative, non-limiting examples).

The designated class 134 indicates which class of object is to be inserted into the scene 124. For example, the designated class 134 may be selected from among a plurality of object classes 136 that may be stored at the memory 110. In some embodiments, one or more instances of a particular object class 136 are also stored as objects 138. In an illustrative example, a first object class 136A corresponds to ‘car,’ and a first set of objects 138A associated with the first object class 136A includes images of cars that have been extracted from one or more other images. The object classes 136 can include one or more additional object classes 136, including an Nth object class 136N, which may correspond to ‘person,’ and an Nth set of objects 138N associated with the Nth object class 136N includes images of people that have been extracted from one or more other images. Although the objects 138 are illustrated as stored in conjunction with the respective object classes 136, in other implementations the objects 138 may not be stored and may instead be generated on-the-fly as instances of selected object classes 136.

The object location model 130 is configured to process the input image 122 to determine, based on the designated class 134 and scene features 132 of the scene 124, a bounding box location 142 and bounding box dimensions 144 for insertion of an object 152 having the designated class 134 into the scene 124. To illustrate, an illustrative example 182 of the input image 122 graphically depicts the scene 124 as a street scene. For example, the input image 122 may have been captured from a camera coupled to or integrated in a vehicle. In the example 182, the scene 124 includes various scene features 132, including a first feature 132A (e.g., a street), a second feature 132B (e.g., a building), and a third feature 132C (e.g., a person), as illustrative, non-limiting examples. According to an aspect, the object location model 130 is configured to detect objects 138 of various object classes 136 (e.g., streets, buildings, people, cars, trucks, trees, sidewalks, etc.) and also additional information such as a depth information (e.g., distance from the camera of each detected object or pixel) and contextual information (e.g., neighboring objects, illumination characteristics, etc. of each detected object or pixel) in conjunction with determining the scene features 132.

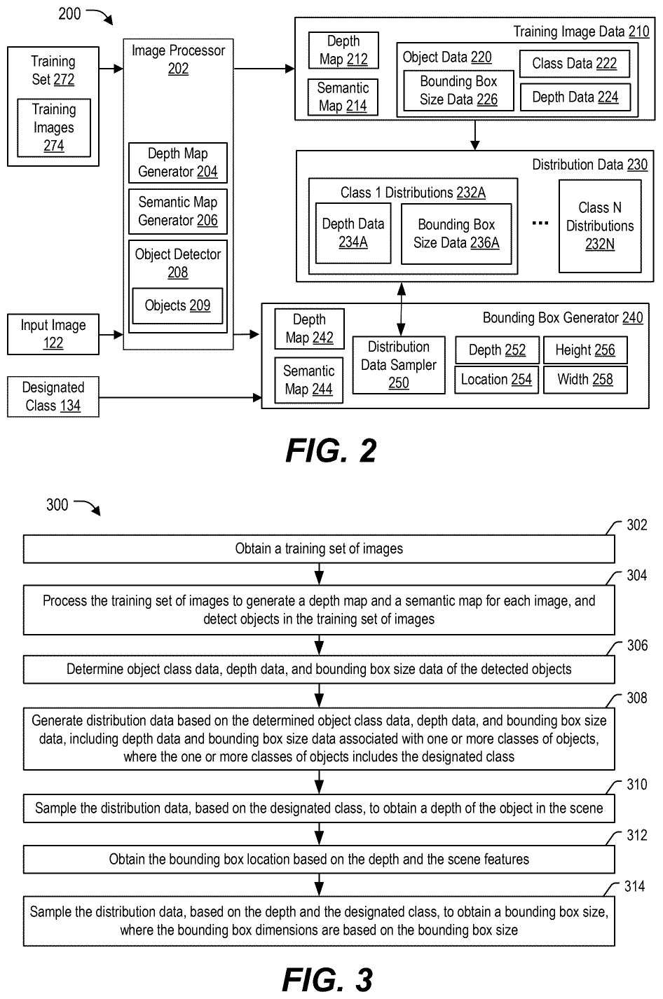

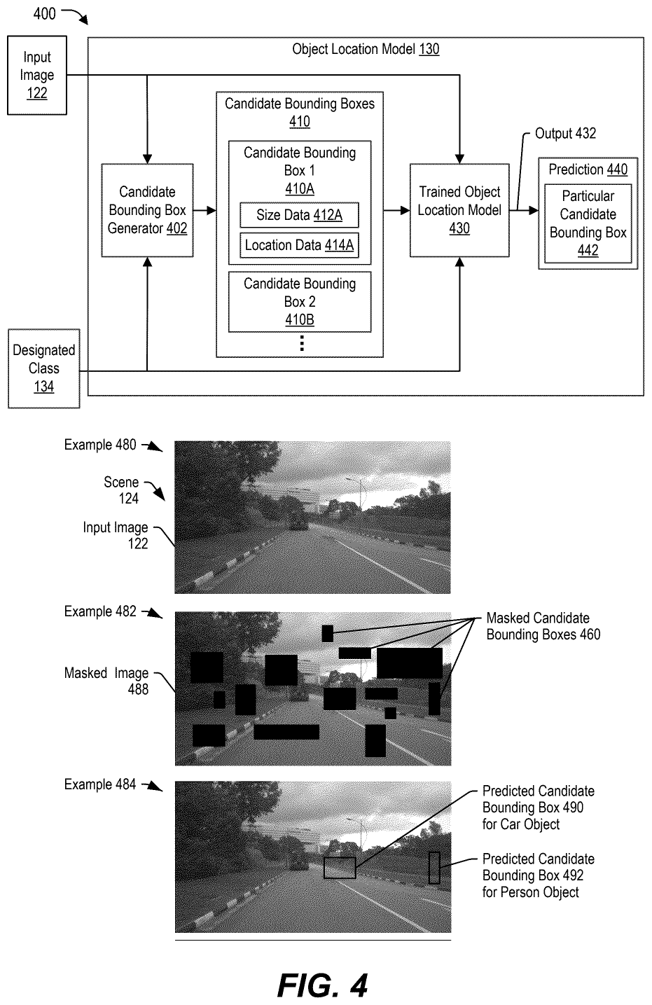

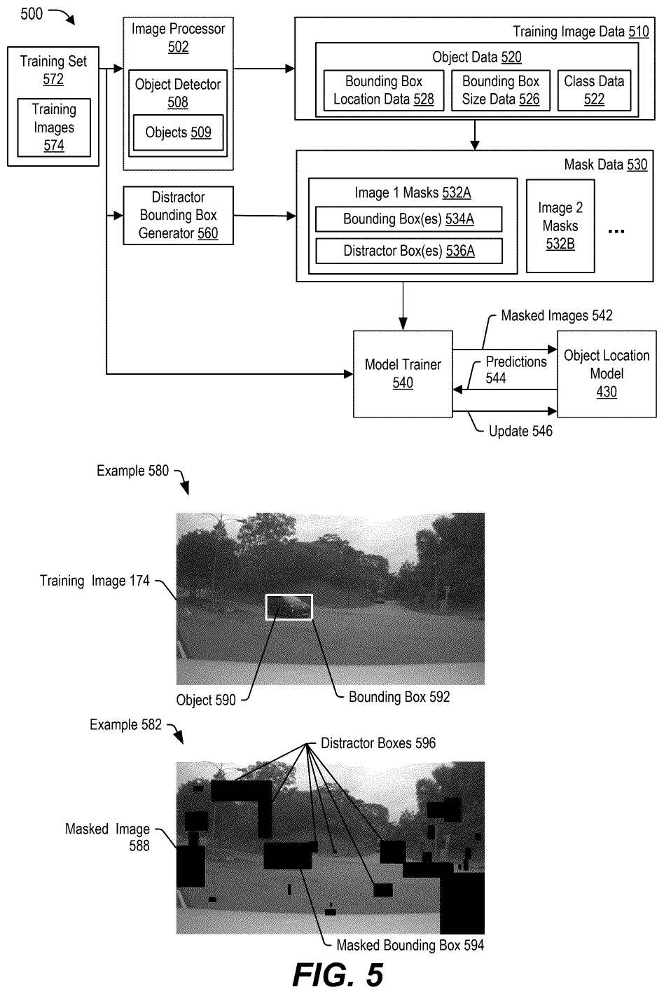

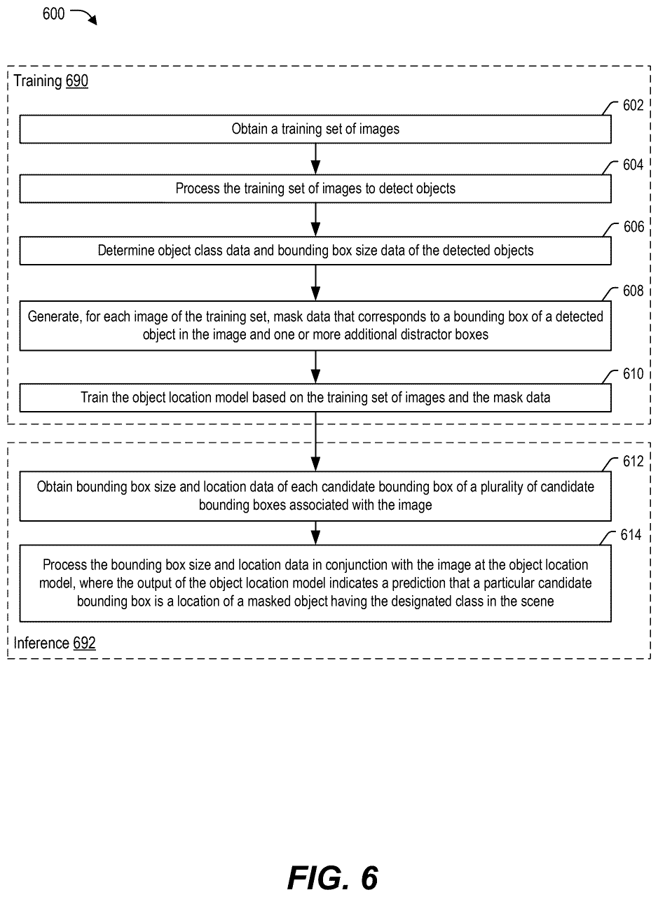

Based on the determined scene features 132, the object location model 130 identifies a particular location of the input image 122 for insertion of an object having the designated class 134 into the scene 124 so that the object ‘makes sense’ or appears realistic—that is, in a location that the object would naturally be located, and having dimensions that are appropriate for the type of object and the depth of the object in the scene 124. Thus, the object location model 130 is ‘scene-aware’ and may extract semantic information and/or estimate depth, either implicitly or explicitly, to determine where to place objects. In some embodiments, the object location model 130 determines the location using a statistics-based model that does not require training, such as described in more detail with reference to FIGS. 2-3. In other embodiments, the object location model 130 determines the location using a trained ML model, such as a deep learning model, such as described in more detail with reference to FIG. 4. Although in some embodiments in which the object location model 130 includes an ML model, the ML model may be trained at the device 102, in other such embodiments the ML model that is not trained at the device 102. To illustrate, the ML model may be trained at a remote device, such as a remote device 198, and the trained ML model may be transmitted to the device 102 and stored in the memory 110. Aspects of training a ML model of the object location model 130 are described in further detail with reference to FIGS. 5-6.

The object location model 130 is configured to output bounding box data 140 corresponding to the selected location for insertion of the object having the designated class 134 into the scene 124. As illustrated, the bounding box data 140 includes a bounding box location 142 and bounding box dimensions 144. In an example, the location 142 indicates a pixel location of a reference point of the bounding box, such as a set of coordinates (x, y), where x is the horizontal location and y is the vertical location of the reference point. The reference point can correspond to the center of the bounding box, or a particular corner (e.g., the lower right corner) of the bounding box, as non-limiting examples. In an example, the dimensions 144 include a set of values (h, w), where h is the pixel height of the bounding box and w is the pixel width of the bounding box. In other examples, the dimensions 144 can include other information associated with the shape of the bounding box, such as a dimension and an aspect ratio of the bounding box.

According to an aspect, the object location model 130 can receive indications of multiple designated classes 134, and/or multiple objects of one or more of the designated class(es) 134, for insertion into the scene 124. In an illustrative example 184, bounding boxes 146 determined by the object location model 130 for insertion of four objects into the street scene of example 182 are graphically depicted. The bounding boxes 146 include a first bounding box 146A for a barrier, a second bounding box 146B for a bus, a third bounding box 146C for a car, and a fourth bounding box 146D for a van. A set of bounding box data 140 is generated by the object location model 130 for each of the bounding boxes 146. To illustrate, the bounding box data 140 for the bounding box 146A includes a location 142 (e.g., a lower left corner of the bounding box 146A), a first dimension 144A indicating the height, and a second dimension 144B indicating the width.

In embodiments in which the processor 116 includes the optional image editor 150, the image editor 150 is configured to generate an updated image 160 that includes an object 152 of the designated class 134 that is inserted at the location 142 and scaled to have a size based on the dimensions 144 of the bounding box data 140. In an illustrative example 186, the portion of the scene 124 within each of the bounding boxes 146 has been modified by the image editor 150 to insert a respective object 152. To illustrate, a first object 152A corresponding to a barrier is inserted in the first bounding box 146A, a second object 152B corresponding to a bus has been inserted in the second bounding box 146B, a third object 152C corresponding to a car has been inserted in the third bounding box 146C, and a fourth object 152D corresponding to a van has been inserted in the fourth bounding box 146D. Although the bounding boxes 146 are graphically depicted in the example 186 to aid in illustrating the positioning of the objects 152, such bounding boxes 146 are typically not included in the updated image 160.

According to an aspect, the image editor 150 generates the updated image 160 using a finetuned inpainting model configured to generate the object 152. In a particular embodiment, the image editor 150 includes, or corresponds to, a pretrained latent diffusion model, such as a Stable Diffusion 2.0—type inpainting model, that is fine-tuned using context crops extracted from real objects in a dataset of images, such as a training set 172 of multiple training images 174. In some aspects, use of a latent diffusion model enables realistic object generation and inpainting from text prompts having the format “image of a <class name>”, where <class name> corresponds to the designated class 134. Use of a fine-tuning stage enables the inpainting model to adapt to pixel-level statistics of the target dataset, to generate images that look natural in the scene 124 in terms of saturation and contrast, to help resolve potential ambiguities in class labels, and to generate objects that fit accurately within the bounding box.

According to some aspects, instead of operating on full resolution frames, an inpainting component of the image editor 150 operates on localized square patches (referred to as ‘context crops’) that are extracted from the input image 122. Each such context crop can contain a bounding box for the object 152 to be inpainted, as well as its category, and extends for twice the larger of the dimensions 144 of the bounding box for the object 152. The image editor 150 may generate each new object independently.

In some embodiments in which the image editor 150 includes a latent diffusion model, when generating an object, the clean latents (resulting from the iterative diffusion process) are once again fed to the denoiser of the latent diffusion model, effectively adding a single additional sampling step, to extract representations for mask decoding. By generating object masks, objects 152 that are generated to be inserted into the scene 124 can be arbitrarily recombined and stacked to create realistic occlusions without artifacts. The mask decoder can also be applied to existing data by re-encoding the existing data with the latent diffusion encoder.

In some embodiments, the device 102 is configured to generate the updated image 160 in conjunction with an interactive image editor 150, such as in a mobile device application for interactive image editing. To illustrate, a user of the device 102 may capture the input image 122 using the image sensor 104, select the designated class 134, and the object location model 130 and the image editor 150 operate to enable editing of the input image 122 via insertion of new objects to generate the updated image 160.

In some embodiments, the processor 116 is configured to include the updated image 160 in a training set of images that can be used to train a ML model. In an example, the processor 116 is configured to generate multiple synthetic images at the image editor 150 and include the synthetic images, including the updated image 160, into the training set 172 to generate an augmented training set 176 for the object detection model 180. To illustrate, the combiner 170 is configured to combine multiple sets of images into a single output set of images. As an example, the training set 172 includes multiple training images 174, and the combiner 170 concatenates, appends, or otherwise inserts the updated image 160 into the training set 172 so that the updated image 160 is used as an additional training image 174 during training of the object detection model 180.

In a particular embodiment, the processor 116 is configured to perform generative data augmentation in which the processor 116 generates and includes the updated image 160 in the augmented training set 176 to oversample one or more object classes, one or more object depths, or both, in the augmented training set 176. For example, the object detection model 180 may correspond to an automotive object detection model, and the training set 172 may have relative few training images 174 that include a person that is relatively close to the camera (e.g., corresponding to a pedestrian in close proximity to a front-facing camera of a car). In order to improve performance of the object detection model 180 in detecting such cases, the processor 116 may generate multiple updated images 160 in which one or more persons have been inserted at appropriate depths, to be added to the training set 172 by the combiner 170 to generate the augmented training set 176 for training the object detection model 180.

The device 102 optionally includes or is coupled to a display device 190 that is coupled to the processor 116 and that is configured to display the updated image 160. To illustrate, the display device 190 is configured to display output data 188 corresponding to, or based on, the updated image 160, for viewing by a user of the device 102. In a particular example, the display device 190 corresponds to display of an extended reality device, such as a virtual reality headset or augmented reality glasses, and the updated image 160 corresponds to a virtual object added to the scene 124, such as in an extended reality application.

The device 102 optionally includes a modem 118 that is coupled to the processor 116 and configured to enable communication with one or more other devices, such as via one or more wireless networks. According to some aspects, the modem 118 is configured to receive the input image 122 from a second device, such as image data (e.g., included in video data) that is streamed via a wireless transmission 194 from a remote device, such as the remote device 198 (e.g., a remote server) for processing at the device 102. According to some aspects, the modem 118 is configured to send data corresponding to the bounding box data 140, the updated image 160, the augmented training set 176, or a combination thereof, to a second device, such as updated image data that is streamed via the wireless transmission 194 to a remote device 198 (e.g., a remote server or user device) for storage or playback. In a particular embodiment, the modem 118 is configured to transmit the bounding box location 142 and the bounding box dimensions 144 to the remote device 198.

A technical advantage of using the object location model 130 is that, as compared to conventional techniques, the object location model 130 provides enhanced accuracy for downstream tasks (e.g., for more realistic updated images generated by the image editor 150, and for more effective augmented training sets to train models such as the object detection model 180), thus improving operation of the device 102.

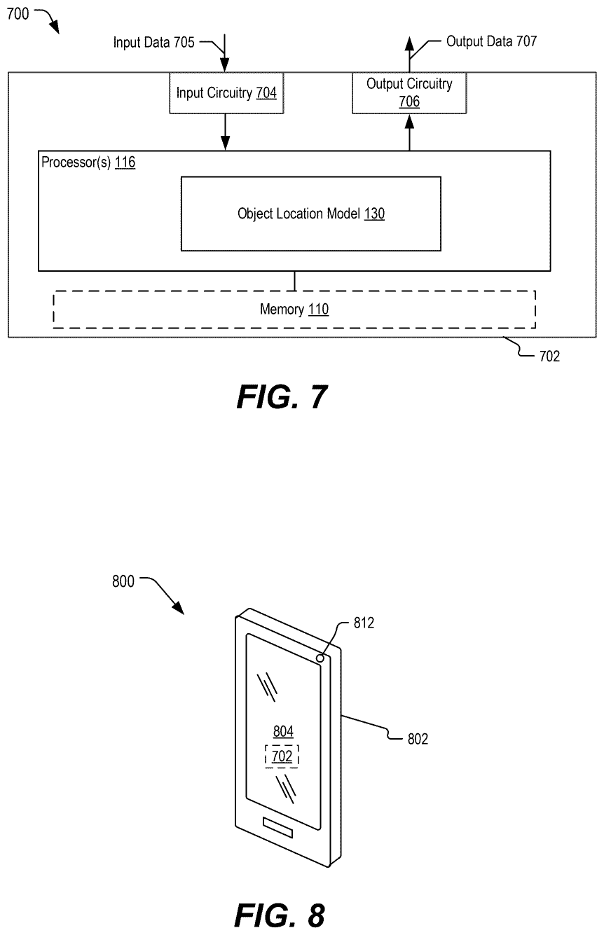

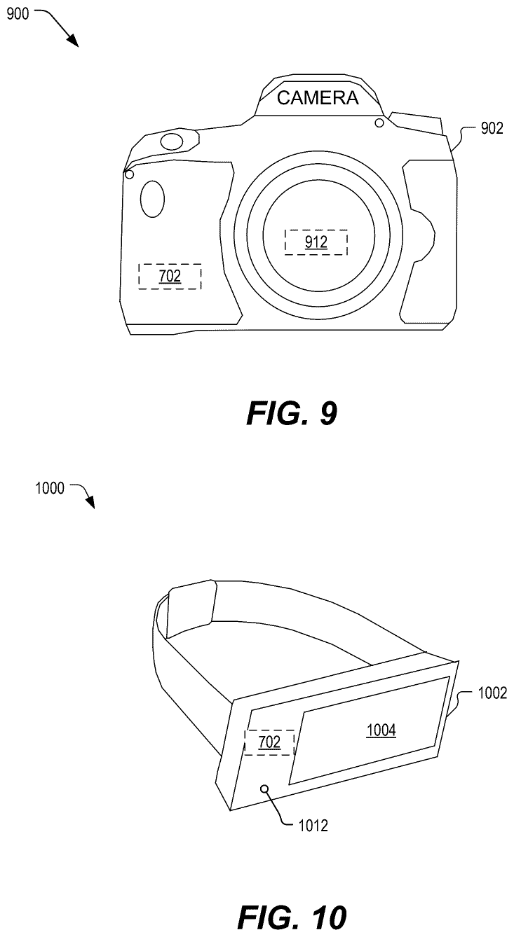

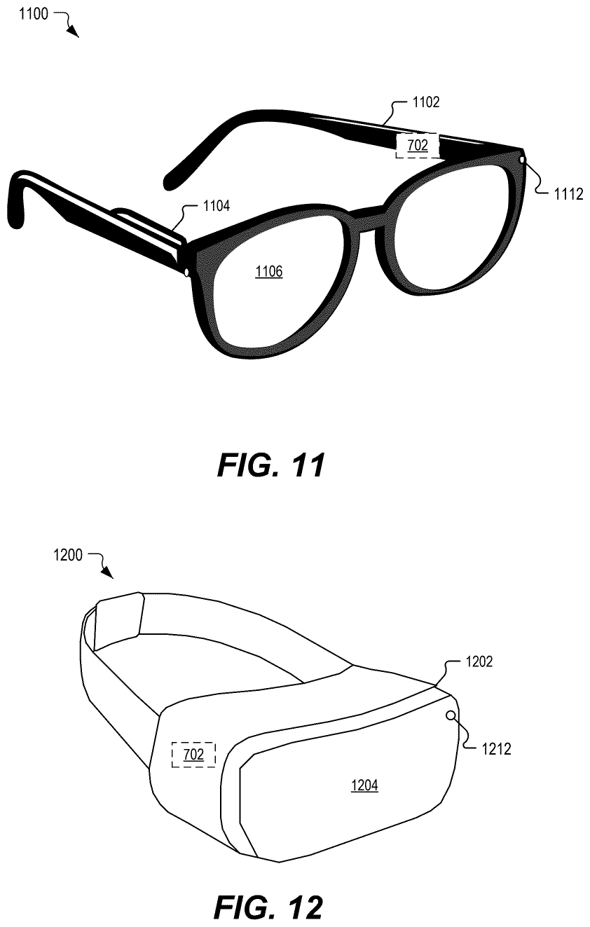

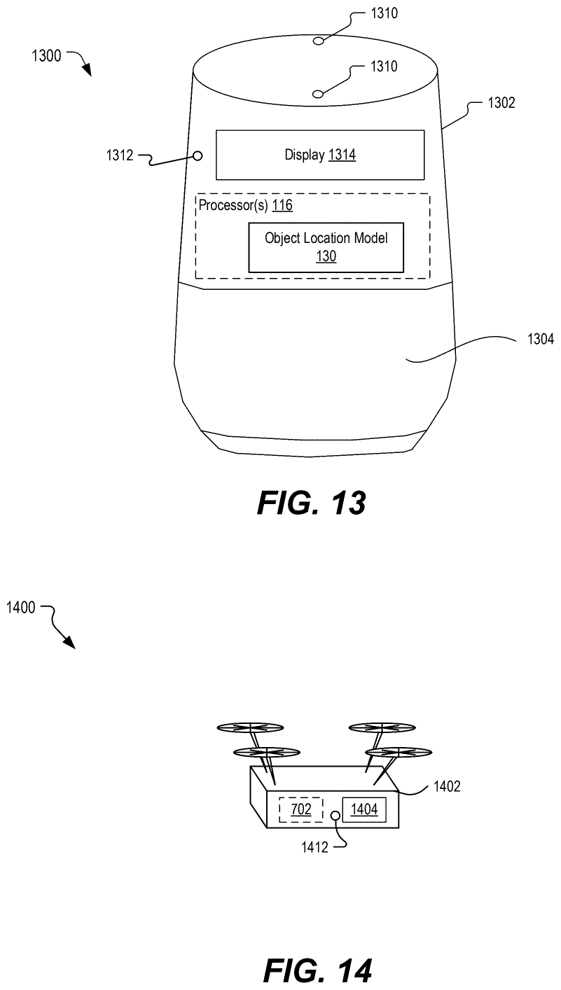

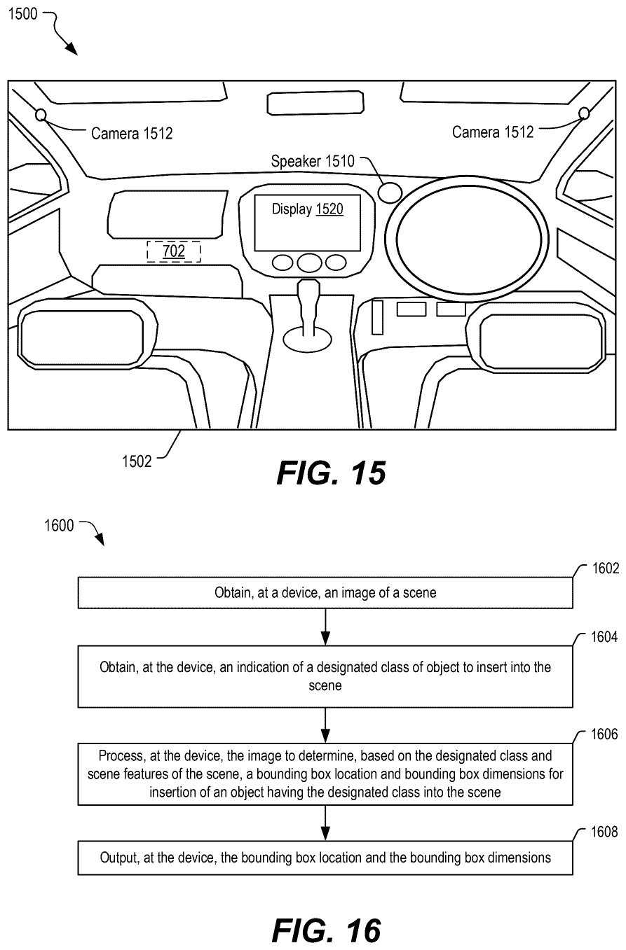

According to some aspects, the processor 116 is integrated in an integrated circuit, such as illustrated in FIG. 7. According to some aspects, the processor 116 is integrated in at least one of a mobile phone or a tablet computer device, such as illustrated in FIG. 8, a camera device, such as illustrated in FIG. 9, or a wearable electronic device, such as illustrated in FIG. 10. According to some aspects, the processor 116 is integrated in a headset device that includes a display and that is configured, when worn by a user, to display an output image based on an output of the object location model 130, such as illustrated in FIG. 11 and FIG. 12. According to some aspects, the processor 116 is integrated in a voice-controlled speaker system, such as illustrated in FIG. 13. According to some aspects, the processor 116 is integrated in a vehicle that also includes one or more cameras configured to capture image data corresponding to the input image 122, such as illustrated in FIG. 14 and FIG. 15.

FIG. 2 depicts an example 200 of components and operations that may be implemented in the device 102 of FIG. 1, according to some examples of the present disclosure. In particular, the example 200 illustrates components of the object location model 130 in an embodiment in which bounding box locations are selected based on factorized probabilistic location modeling, as explained further below.

In the example 200, a bounding box generator 240 is configured to determine bounding box data (e.g., the bounding box data 140 of FIG. 1) based on information about the input image 122, such as a depth map 242 and a semantic map 244 for the input image 122, and also based on distribution data 230 that is associated with statistics collected from a dataset of images. In the illustrated example 200, the dataset of images is a training set 272 of training images 274 that is to be augmented with one or more synthesized images to produce an augmented training set for training an object detection model. In an example, the training set 272 corresponds to the training set 172 of FIG. 1.

The bounding box generator 240 is configured to obtain the depth map 242 and the semantic map 244 from an image processor 202. The image processor 202 includes a depth map generator 204 that is configured to process the input image 122 to generate the depth map 242. To illustrate, the depth map 242 can include depth information for each pixel of the input image 122 and may be determined by processing the input image 122 using a ML model, such as one or more convolutional neural networks (CNNs), that is trained to estimate depth from a received image. In some examples, depth information is determined using grayscale gradients, edge strength and orientation, geometric features, etc., of the input image 122. Alternatively, or in addition, in some embodiments the depth map generator 204 can determine the depth map 242 based on additional information that may be received in conjunction with the input image 122, such as when the input image 122 is included in a pair of stereo images, when the input image 122 is included in a sequence of images to enable optical flow techniques, or when additional sensor data is provided from a sensor system such as lidar or structured light.

The semantic map 244 is generated by a semantic map generator 206 of the image processor 202. The semantic map generator 206 is configured to process the input image 122 to generate the semantic map 244, which may associate each pixel of the input image 122 with a particular class (e.g., street, car, person, tree, building, etc.). In an illustrative example, the semantic map generator 206 may generate the semantic map 244 by extracting features from the input image 122 and performing classification and segmentation based on the extracted features.

The distribution data 230 includes depth data 234 and bounding box size data 236 associated with one or more classes of objects. For example, the distribution data 230 includes multiple class distributions 232, such as distributions 232A for a first class of objects (e.g., cars) detected in the training set 272 and one or more additional sets of distributions for one or more other classes of objects, including Nth distributions 232N for an Nth class of objects (e.g., people) detected in the training set 272. Each of the class distributions 232 includes depth data 234 and bounding box size data 236 for the associated class. For example, when the distributions 232A are associated with cars, depth data 234A of the distributions 232A can include an empirical distribution of depths of detected cars or a model that approximates the empirical distribution, such as a log-normal distribution (as a non-limiting example) that is fit to the empirical distribution of detected car depths in the training images 274. Similarly, bounding box size data 236A can include an empirical distribution of heights of the detected cars at different depth intervals, car widths at different depth intervals, and/or aspect ratios of cars independent of depth, or one or more models that approximate one or more of the empirical height, weight, and/or aspect ratio distributions, or a combination thereof.

The bounding box generator 240 includes a distribution data sampler 250 that is configured to sample the distribution data 230, based on the designated class 134, to obtain a depth 252 of an object (e.g., the object 152 of FIG. 1) to be inserted in the scene 124. According to an aspect, the one or more classes of objects associated with the class distributions 232 includes the designated class 134, and the distribution data sampler 250 is configured to compare the class distributions 232 to the designated class 134 to locate a corresponding distribution. Continuing the above example, when the designated class 134 corresponds to cars, the distribution data sampler 250 determines that the first class (cars) corresponding to the distributions 232A matches the designated class 134. The distribution data sampler 250 samples the depth data 234A to determine a realistic value of the depth 252 for insertion of a car object into the scene 124.

According to an aspect, the bounding box generator 240 is configured to obtain a location 254 of the bounding box based on the depth 252 and the scene features of the scene 124. Continuing the above example, the bounding box generator 240 selects the location 254 from the drivable space in the scene 124, as indicated in the semantic map 244. To illustrate, pixels of the input image 122 that correspond to features in the scene 124 where it would be natural for a car to be located, such as roads, bridges, grass, etc., may be identified via the semantic map 244 and designated as drivable space in the scene 124. The location 254 may be sampled (e.g., uniformly at random) from the drivable space in the scene 124, limited to locations with depths that are within a depth threshold to the sampled depth 252.

According to an aspect, the distribution data sampler 250 is configured to sample the distribution data 230, based on the depth 252 and the designated class 134, to obtain a bounding box size. To illustrate, continuing the above example, the distribution data sampler 250 samples the bounding box size data 236A for a depth interval associated with the depth 252 to determine bounding box size data, such as a realistic value of a height 256 for the given depth 252 of the car to be inserted into the scene 124. The distribution data sampler 250 may also sample the bounding box size data 236A for an aspect ratio (e.g., based on the height 256 and independent of depth), which is used to obtain a width 258. According to an aspect, the bounding box dimensions 144 of FIG. 1 are based on the bounding box size and include the height 256 and the width 258.

In some embodiments, the distribution data 230 is generated by the object location model 130 based on processing the training set 272. For example, the image processor 202 includes an object detector 208 that is configured to process the training set 272 to detect objects 209 in the training images 274 of the training set 272. To illustrate, the image processor 202 is configured to generate training image data 210 for each of the training images 274. The training image data 210 for a particular image includes a depth map 212 for the image (e.g., generated by the depth map generator 204), a semantic map 214 for the image (e.g., generated by the semantic map generator 206), and a set of object data 220 for each of the objects 209 detected in the image by the object detector 208. To illustrate, the object detector 208 may be configured to determine object class data 222 that indicates a class of a particular object, depth data 224 that indicates the depth of the particular object based on the depth map 212, and bounding box size data 226 (e.g., height and aspect ratio of a bounding box that is determined for the particular object) for each the detected objects 209 in the image.

The processor 116 (e.g., the object location model 130) may be configured to generate the distribution data 230 based on the determined object class data 222, depth data 224, and bounding box size data 226 from the training image data 210 for each of the training images 274. To illustrate, the object data 220 for each object 209 having a particular object class in the training images 274 may be aggregated to determine the depth data 234 and the bounding box size data 236 for the particular object class. One or more of the class distributions 232 may be empirical (e.g., histograms), one or more of the class distributions 232 may be fit to an appropriate distribution, or a combination thereof. In a particular example, aspect ratio distributions in the distribution data 230 are empirical, while the distributions for the depth data 234 and the object height are fit to a log-normal distribution.

During operation, generation of the depth 252, the location 254, the height 256, and the width 258 of a bounding box for an object having the designated class 134 is determined based on the depth map 242, the semantic map 244, and the distribution data 230. A conditional probability density for such a bounding box may be expressed according to a sequence of sampling steps as in the following equation:

$$p ( x , y , w , h \vert D , S , c ) = p ( w \vert h , c ) \cdot p ( h \vert d , c ) \cdot p ( x , y \vert d , S ) \cdot p ( d \vert c ) ,$$

where x, y correspond to the location 254 of the bounding box; w, h correspond to the width 258 and height 256, respectively, of the bounding box; D is the depth map 242; S is the semantic map 244; c is the designated class 134, and d is the depth 252.

According to a particular embodiment, the sequence of sampling steps include:
1. Sample a depth: for a designated class c, sample a depth d. p(d|c) may be approximated by a log-normal distribution.
2. Sample a location: for the depth d and taking the scene as (e.g., drivable space) into account, sample a location (x, y). p(x, y|d, S) may be uniform.
3. Sample a height: for the depth d and the designated class c, sample a height h of the bounding box for the object. p (h|d, c) may be approximated by a log-normal distribution.
4. Sample a width: for the height h and the designated class c, sample an aspect ratio of the bounding box for the object, and use the aspect ratio to determine the width w. p(w|h, c) may be empirical (e.g., Naïve Bayes).
   A further example of operations that may be performed in association with factorized probabilistic location modeling of FIG. 2 is described with reference to FIG. 3.

FIG. 3 depicts an example 300 of operations that can be performed by the device 102 of FIG. 1, according to some examples of the present disclosure. In particular, the operations may be implemented as described with respect to the example 200 of FIG. 2. For example, the operations may be implemented by the object location model 130 of FIG. 1, such as by the image processor 202 of FIG. 2 and the bounding box generator 240 of FIG. 2.

The example 300 includes obtaining a training set of images, at block 302. For example, the training set of images can correspond to the training set 272 that includes the training images 274 of FIG. 2.

The training set of images is processed to generate a depth map and a semantic map for each image, and to detect objects in the training set of images, at block 304. For example, the depth map generator 204 of the image processor 202 generates the depth map 212 for each of the training images 274, the semantic map generator 206 of the image processor 202 generates the semantic map 244 for each of the training images 274, and the object detector 208 of the image processor 202 detects objects 209 in each of the training images 274.

The object class data, depth data, and bounding box size data of the detected objects are determined, at block 306. For example, the object class data 222 the depth data 224, and the bounding box size data 226 of the training image data 210 of FIG. 2 are determined by the image processor 202 for each of the training images 274.

Distribution data is generated based on the determined object class data, depth data, and bounding box size data, including depth data and bounding box size data associated with one or more classes of objects, where the one or more classes of objects includes the designated class, at block 308. For example, the distribution data 230 including the depth data 234 and the bounding box size data 236 of each of the class distributions 232 is generated by the processor 116 of FIG. 1, such as the object location model 130, based on the object class data 222, the depth data 224, and the bounding box size data 226 in the training image data 210.

The distribution data is sampled, based on the designated class, to obtain a depth of the object in the scene, at block 310. For example, the distribution data sampler 250 of the bounding box generator 240 of FIG. 2 samples the depth data 234 based on the designated class 134 to obtain the depth 252.

The bounding box location is obtained based on the depth and the scene features, at block 312. For example, when the object corresponds to a car, the location 254 can be determined randomly from among the drivable spaces in the input image 122, as indicated by the semantic map 244, that corresponds to the depth 252.

The distribution data is sampled, based on the depth and the designated class, to obtain a bounding box size, where the bounding box dimensions are based on the bounding box size, at block 314. For example, the distribution data sampler 250 samples the height 256 based on the depth 252 and the designated class 134, and samples the bounding box size data 236 to obtain the width 258 based on the height 256 and the designated class 134. For example, the distribution data sampler 250 may sample the bounding box size data 236 based on the designated class 134 to obtain an aspect ratio, and the object location model 130 may determine the width 258 based on the height 256 and the aspect ratio.

The operations of the example 300 may generally correspond to two phases of operation: a fitting phase, and a sampling phase. In the fitting phase (e.g., blocks 302-308), the depth map and semantic map are generated for each image of a training set, and for each class of object detected in each of the images, the class distributions 232 are generated. For example, the depth data 234 can be generated by fitting the depth data 224 of the training image data 210 to a log-normal distribution p(d|c), and the bounding box size data 236 can include height data that is generated by fitting height data of the bounding box size data 226 of the training image data 210 to a log-normal distribution p(h|d, c). The bounding box size data 236 can also include width data that is generated by collecting an empirical distribution p(w|h, c).

In the sampling phase (e.g., blocks 310-314), the depth map and the semantic map are generated for an input image, and for a desired class of object to be inserted into the input image, a depth value is sampled from p(d|c), and a random pixel x, y is sampled from among the pixels having depth d and a “legitimate semantic” (e.g., a drivable surface). In addition, for the desired class a height is sampled from p(h|d, c), and a width is sampled from p(w|h, c).

Use of the above-described sequence of sampling operations to determine the boundary box for insertion of a particular class of object enables the processor 116 to determine, restrict, bias, or otherwise control one or more of the object class, the depth, the location, and the dimensions of the boundary box. Such control enables customization that can be used to oversample some classes, some specific depths, etc., such as described with refence to generating the augmented training set 176 for training the object detection model 180 of FIG. 1.

FIG. 4 depicts an example 400 of components and operations that can be implemented in the system 100 of FIG. 1, in accordance with some examples of the present disclosure. In particular, the example 400 graphically depicts operations and components that can be implemented in the object location model 130 of FIG. 1. As compared to the factorized probabilistic location modeling of FIGS. 3-4, the object location model 130 of the example 400 performs deep learning-based location modeling using a trained object location model 430. The example 400 corresponds to an inference phase of the trained object location model 430; an example of training the object location model 430 is provided in FIG. 5.

In the example 400, the object location model 130 includes a candidate bounding box generator 402 that is configured to generate a plurality of candidate bounding boxes 410 for the input image 122. For example, the candidate bounding boxes 410 include a first candidate bounding box 410A, a second candidate bounding box 410B, and one or more additional candidate bounding boxes 410. Each of the candidate bounding boxes 410 includes size data 412 (e.g., width and height) and location data 414 (e.g., horizontal and vertical positions) for the respective candidate bounding box. For example, the first candidate bounding box 410A includes first size data 412A and first location data 414A. The candidate bounding boxes 410 may be generated randomly or pseudo-randomly, and each of the candidate bounding boxes 410 corresponds to a potential location in the input image 122 that may be chosen by the object location model 430 for insertion of an object having the designated class 134.

The object location model 430 is configured to obtain the input image 122, the designated class 134, and bounding box size and location data (e.g., the size data 412 and the location data 414) of each candidate bounding box 410 of the plurality of candidate bounding boxes 410 associated with the input image 122. According to an example, the object location model 130 is configured to generate a masked version of the input image 122 by masking (e.g., overwriting pixel values of) regions of the input image 122 within each of the candidate bounding boxes 410. To illustrate, an illustrative example 480 of the input image 122 graphically depicts the scene 124 as a street scene. For example, the input image 122 may have been captured from a camera coupled to or integrated in a vehicle. An example 482 depicts a masked image 488 corresponding to a masked version of the input image 122 after multiple masked candidate bounding boxes 460 are inserted. Each of the masked candidate bounding boxes 460 corresponds to one of the candidate bounding boxes 410. In this example, the masked image 488 is provided as input to the trained object location model 430 instead of individually providing the input image 122 and the candidate bounding boxes 410 to the object location model 430.

The trained object location model 430 is configured to generate one or more predictions of a location of a masked object in an input scene. For example, the trained object location model 430 is configured to generate an output 432 that includes a prediction 440 of a particular candidate bounding box 442, from among the plurality of candidate bounding boxes 410, that corresponds to a masked object of the input image 122. As described further with reference to FIG. 5, the trained object location model 430 is trained to receive an image of a scene in which multiple masking boxes have been inserted, and to predict which of the masking boxes covers a designated class of object in the scene.

According to an aspect, the trained object location model 430 processes the bounding box size and location data in conjunction with the image 122 (e.g., received as a masked version of the input image 122), and the output 432 of the trained object location model 430 indicates a prediction 440 that the particular candidate bounding box 442 of the plurality of candidate bounding boxes 410 is a location of a masked object having the designated class 134 in the scene 124. However, because none of the candidate bounding boxes 410 (e.g., none of the masked candidate bounding boxes 460) correspond to an object in the original scene 124, the prediction 440 by the trained object location model 430 indicates which of the candidate bounding boxes 410 has the most plausible location and size for insertion of an instance of the designated class 134 into the scene 124. To illustrate, an example 484 depicts a predicted candidate bounding box 490 as the most plausible, from among the multiple candidate bounding boxes 410, for a car object, and a predicted candidate bounding box 492 as the most plausible, from among the multiple candidate bounding boxes 410, for a person object.

The object location model 130 is configured to determine the bounding box location 142 and the bounding box dimensions 144 of FIG. 1 based on the output 432 of the trained object location model 430. To illustrate, in some embodiments, the location 142 and the dimensions 144 of the bounding box data 140 correspond to the location data 414 and the size data 412, respectively of the particular candidate bounding box 442.

FIG. 5 depicts an example 500 of components and operations that can be implemented in the system 100 of FIG. 1, in accordance with some examples of the present disclosure. In particular, the example 500 graphically depicts operations and components that can be implemented to train the object location model 430 of FIG. 4. Although in some embodiments the components and operations depicted in the example 500 are implemented in the device 102, such as included in and performed by the processor 116, in other implementations the components and operations are instead implemented in another device, such as the remote device 198 of FIG. 1, to train the object location model 430, and the trained object location model 430 may be transmitted to the device 102 via the modem 118 for storage in the memory 110.

In the example 500, an image processor 502 is configured to obtain a training set of images, illustrated as a training set 572 that includes multiple training images 574. The image processor 502 includes an object detector 508 that is configured to process the training set 572 to detect objects 509 in each of the training images 574. The object detector 508 is also configured to determine object class data 522, bounding box size data 526, and bounding box location data 528 of the detected objects 509, which are included in object data 520 within training image data 510 for the training images 574. In an illustrative example, the object detector 508 corresponds to the object detector 208 of FIG. 2, and the object class data 522 and the bounding box size data 526 correspond to the object class data 222 and the bounding box size data 226, respectively.

The bounding box size data 526 and the bounding box location data 528 for each object 509 that is detected in each of the training images 574 are used as size and location data for one or more bounding boxes 534 in a set of one or more masks 532 in mask data 530. For example, the mask data 530 includes, for each of the training images 574, descriptions (e.g., locations and sizes) of each bounding box for each object 509 that is detected in that training image 574. The mask data also includes, for each of the training images 574, one or more distractor boxes 536. For example, the mask data 530 includes a set of masks 532A for a first image of the training set 572. The masks 532A include one or more bounding boxes 534A that correspond to objects in the first image and one or more distractor boxes 536A that do not correspond to objects in the first image.

The distractor boxes 536 are generated by a distractor bounding box generator 560. In a particular embodiment, the distractor bounding box generator 560 is configured to generate one or more of the distractor boxes 536 for a particular training image 574 randomly (e.g., having a randomly selected location and size), and to generate one or more others of the distractor boxes 536 for the particular training image from the bounding boxes 534 of one or more other images. To illustrate, the distractor boxes 536A of the masks 532A for the first image of the training set 572 can include the bounding box(es) 534 of the masks 532B for the second image of the training set 572, and vice versa. Using bounding boxes 534 of other images as distractor boxes 536 for a given image provides a greater challenge for the object location model 430 because the size, and shape, and location of such distractor boxes 536 are generally more plausible than randomly generated distractor boxes 536.

A model trainer 540 is configured to train the object location model 430 based on the training set 572 and the mask data 530. For example, the model trainer 540 may generate masked images 542 for processing by the object location model 430. Each masked image 542 can correspond to an updated version of a corresponding training image 574 in which pixel values within each of the bounding boxes 534 and the distractor boxes 536 for that training image have been overwritten. The object location model 430 processes each masked image 542 and generates a corresponding prediction 544 of which of the masks in the masked image 542 corresponds to a bounding box 534 for an object in the corresponding training image 174. The model trainer 540 compares the predictions 544 to ground truth (e.g., the bounding box(es) 534 for that training image), computes a loss function, and sends an update instruction 546 to update the object location model 430 based on the loss function.

In an illustrative example 580, a training image 174 is depicted that includes an object 590 (a car) and a bounding box 592 for the object 590. An example 582 depicts a masked image 588 corresponding to an updated version of the training image 174 in which a masked bounding box 594 positioned to conceal the object 590 and multiple distractor boxes 596 have been added. In this example, the masked image 588 is provided as one of the masked images 542 to the object location model 430 during training.

FIG. 6 depicts an example 600 of operations that may be implemented in the system 100 of FIG. 1. In particular, the example 600 illustrates operations that may be performed in conjunction with training and inference of the object location model 130 including the object location model 430 of FIG. 4 and FIG. 5.

A training process 690 includes obtaining a training set of images, at block 602. For example, the image processor 502 of FIG. 5 obtains the training set 572 including the training images 574.

The training process 690 includes processing the training set of images to detect objects, at block 604. For example, the object detector 508 of the image processor 502 processes the training set 572 to detect the objects 509.

The training process 690 includes determining object class data and bounding box size data of the detected objects, at block 606. For example, the image processor 502, e.g., the object detector 508, determines the object data 520 including the object class data 522 and the bounding box size data 526.

The training process 690 includes generating, for each image of the training set, mask data that corresponds to a bounding box of a detected object in the image and one or more additional distractor boxes, at block 608. In an example, the processor 116 of FIG. 1 generates the mask data 530 including the one or more bounding boxes 534 and the one or more distractor boxes 536 for each of the training images 574.

The training process 690 also includes training the object location model based on the training set of images and the mask data, at block 610. For example, the model trainer 540 generates and sends the masked images 542 to the object location model 430, receives the corresponding predictions 544 of the object location model 430, and updates the object location model 430 via the update instruction 546.

An inference process 692 includes obtaining bounding box size and location data of each candidate bounding box of a plurality of candidate bounding boxes associated with an image, at block 612. For example, the trained object location model 430 of FIG. 4 receives the candidate bounding boxes 410 including the size data 412 and the location data 414 associated with the input image 122, such as by receiving the masked image 488 as a masked version of the input image 122.

The inference process 692 also includes processing the bounding box size and location data in conjunction with the image at the object location model, where the output of the object location model indicates a prediction that a particular candidate bounding box is a location of a masked object having the designated class in the scene, at block 614. For example, the object location model 430 of FIG. 4 processes the size data 412 and the location data 414 of the candidate bounding boxes 410 in conjunction with the input image 122, such as by processing the masked image 488.

Although in some embodiments the operations of the training process 690 and the inference process 692 are implemented in the device 102, such as included in and performed by the processor 116, in other implementations the training process 690 and the inference process 692 are performed at separate devices. For example, the inference process 692 may be performed at a training device, such as the remote device 198 of FIG. 1, to train the object location model 430, and the trained object location model 430 may be transmitted to an inference device, such as the device 102, and the inference process 692 may be performed at the device 102, such as during operation of the object location model 130.

FIG. 7 is a block diagram illustrating an example 700 of the device 102 as an integrated circuit 702 for determining a location for object insertion into a scene. The integrated circuit 702 includes the one or more processors 116, which include the object location model 130 (e.g., including the image processor 202 and the bounding box generator 240 of FIG. 2, the candidate bounding box generator 402 and the object location model 430 of FIG. 4, or a combination thereof). The integrated circuit 702 also includes input circuitry 704, such as a bus interface, to enable input data 705, such as the image data 105 or the input image 122, to be received. The integrated circuit 702 includes output circuitry 706, such as a bus interface, to enable outputting of output data 707, such as the bounding box data 140, the updated image 160, the augmented training set 176, or data associated with the trained object detection model 180. Optionally, the integrated circuit 702 also includes the memory 110, the image sensor 104, the input image source 120, the image editor 150, the combiner 170, the object detection model 180, the modem 118, a display engine, etc. The integrated circuit 702 enables implementation of input data processing (e.g., determining a location for object insertion into a scene) as a component in a system that performs image processing, such as depicted in FIG. 1.

FIG. 8 depicts an example 800 in which the device 102 includes a mobile device 802, such as a phone or tablet, as illustrative, non-limiting examples. The mobile device 802 includes a display screen 804 and a camera 812 (e.g., the image sensor 104). The object location model 130 is integrated in the mobile device 802, such as in the integrated circuit 702, which is illustrated using dashed lines to indicate internal components that are not generally visible to a user of the mobile device 802. In a particular example, the object location model 130 operates to determine a location for object insertion into a scene. For example, the mobile device 802 may capture the input image 122 at the camera 812, process the input image 122 using the object location model 130, and display the resulting updated image 160 at the display screen 804 and/or transmit the resulting updated image 160 or the bounding box data 140 to another device, such as the remote device 198.

FIG. 9 depicts an example 900 in which the device 102 includes a portable electronic device that corresponds to a camera device 902. The camera device 902 includes an image sensor 912, such as the image sensor 104. The object location model 130 is integrated in the camera device 902, such as in the integrated circuit 702. In a particular example, the object location model 130 operates to determine a location for object insertion into a scene. For example, the camera device 902 may capture the input image 122 at the image sensor 912, process the input image 122 using the object location model 130, and display the resulting updated image 160 at a display screen of the camera device 902, store the resulting updated image 160 or the bounding box data 140 at a memory of the camera device 902, and/or transmit the resulting updated image 160 or the bounding box data 140 to another device, such as the remote device 198.

FIG. 10 depicts an example 1000 of a wearable electronic device 1002, illustrated as a “smart watch.” In a particular aspect, the wearable electronic device 1002 includes the device 102. The wearable electronic device 1002 includes a display screen 1004 and a camera 1012 (e.g., the image sensor 104). The object location model 130 is integrated in the wearable electronic device 1002, such as in the integrated circuit 702. In a particular example, the wearable electronic device 1002 includes a haptic device that provides a haptic notification (e.g., vibrates) associated with display of image or video data that is based on image or video data that been captured by the camera 1012 and processed by the object location model 130, such as the updated image 160, which may be displayed via the display screen 1004. For example, the haptic notification can cause a user to look at the wearable electronic device 1002 to watch video playback including images into which an object has been inserted.

FIG. 11 depicts an example 1100 in which the device 102 includes a portable electronic device that corresponds to an extended reality device, such as augmented reality or mixed reality glasses 1102. The glasses 1102 include a holographic projection unit 1104 configured to project visual data onto a surface of a lens 1106 or to reflect the visual data off of a surface of the lens 1106 and onto the wearer's retina. The glasses 1102 include a camera 1112, such as the image sensor 104. The object location model 130 is integrated in the glasses 1102, such as in the integrated circuit 702. In a particular example, the object location model 130 operates to determine a location for object insertion into a scene. For example, the input image 122 may be captured by the camera 1112, processed using the object location model 130, and the resulting updated image 160 (e.g., an output image based on an output of the object location model 130) may be displayed via a projection onto the surface of the lens 1106 to enable display of images and/or video associated with augmented reality, mixed reality, or virtual reality scenes in which one or more object have been inserted, to the user while the glasses 1102 are worn.

FIG. 12 depicts an example 1200 in which the device 102 includes a portable electronic device that corresponds to a virtual reality, augmented reality, or mixed reality headset 1202. The headset 1202 includes a camera 1212, such as the image sensor 104, and a visual display device 1204. The object location model 130 is integrated in the headset 1202, such as in the integrated circuit 702. In a particular example, the object location model 130 operates to determine a location for object insertion into a scene. For example, the input image 122 may be captured by the camera 1212, processed using the object location model 130, and the resulting updated image 160 (e.g., an output image based on an output of the object location model 130) may be displayed at the visual display device 1204 to enable display of images and/or video associated with augmented reality, mixed reality, or virtual reality scenes in which one or more objects have been inserted, to the user while the headset 1202 is worn.

FIG. 13 is an example 1300 of a wireless speaker and voice activated device 1302. In a particular aspect, the wireless speaker and voice activated device 1302 includes the device 102. The wireless speaker and voice activated device 1302 can have wireless network connectivity and is configured to execute an assistant operation. The one or more processors 116 are included in the wireless speaker and voice activated device 1302 and include the object location model 130.

The wireless speaker and voice activated device 1302 includes a camera 1312, such as the image sensor 104, and a display device 1314. In a particular example, the object location model 130 operates to determine a location for object insertion into a scene. For example, the input image 122 may be captured by the camera 1312 and processed using the object location model 130, and the resulting updated image 160 (e.g., an output image based on an output of the object location model 130) may be displayed at the display device 1314 and/or transmitted to a remote device, such as the remote device 198, for playback at the remote device.

In a particular aspect, the wireless speaker and voice activated device 1302 includes one or more microphones 1310 and one or more speakers 1304. During operation, in response to receiving a verbal command via the one or more microphones 1310, the wireless speaker and voice activated device 1302 can execute assistant operations, such as via execution of a voice activation system (e.g., an integrated assistant application). The assistant operations can include activating the camera 1312 to capture video or image content, inserting an object into the video or image content, and displaying output image or video data based on the captured video content (e.g., the updated image 160) at the display device 1314. In some examples, the assistant operations are performed responsive to receiving a command after a keyword or key phrase (e.g., “hello assistant”) received via the one or more microphones 1310.

FIG. 14 depicts a first example 1400 in which the device 102 corresponds to or is integrated within a vehicle 1402, illustrated as a manned or unmanned aerial device (e.g., a package delivery drone). The object location model 130 is integrated in the vehicle 1402, such as in the integrated circuit 702. The vehicle 1402 may also include a display device 1404 configured to display an output based on processing input data at the object location model 130, such as the updated image 160.

In some implementations, the vehicle 1402 is manned (e.g., carries a pilot, one or more passengers, or both), the display device 1404 is internal to a cabin of the vehicle 1402, and the input data processing (e.g., determining a location for object insertion) is performed using image and/or video capture via one or more cameras 1412. The input data processing may be used to generate navigational data, such as to insert a visual indication of one or more objects into a scene in the proximity of the vehicle 1402, such as for playback to a pilot or a passenger of the vehicle 1402 and/or for semi-autonomous or autonomous operation of the vehicle 1402 during a training exercise. In another implementation, the vehicle 1402 is unmanned, the input data processing (e.g., determining a location for object insertion) is performed using image and/or video captured via the one or more cameras 1412 to generate navigational data corresponding to one or more objects inserted into a scene in the proximity of the vehicle 1402, which may be displayed to a remote operator of the vehicle 1402 for training purposes, and/or used for training or testing semi-autonomous or autonomous operation of the vehicle 1402.

In some embodiments, the display device 1404 and the camera 1412 are mounted to an external surface of the vehicle 1402, and the input data processing at the object location model 130 is performed during video playback to one or more viewers external to the vehicle 1402. For example, the vehicle 1402 may move (e.g., circle an outdoor audience during a concert) while playing out video or images based on video or image data captured via the camera 1412.

FIG. 15 depicts a second example 1500 in which the device 102 corresponds to, or is integrated within, a vehicle 1502, illustrated as a car. The object location model 130 is integrated in the vehicle 1502, such as in the integrated circuit 702. In a particular example, the object location model 130 operates to perform input data processing based on image data received from one or more cameras 1512. The input data processing (e.g., determining a location for object insertion into a scene) may be used to generate navigational data, such to insert a visual indicator of one or more objects into a scene in the proximity of the vehicle 1502, such as for playback of the navigational data to an operator of the vehicle 1502 via a display screen 1520 (e.g. in conjunction with a driver training exercise), and/or for testing of semi-autonomous or autonomous operation of the vehicle 1502.

For example, in a particular embodiment, the vehicle 1502 may capture the input image 122 using the one or more cameras 1512, process the input image 122 at the object location model 130, and display the resulting updated image 160 at the display screen 1520 of the vehicle 1502, store the resulting updated image 160 and/or the bounding box data 140 at a memory of the vehicle 1502, and/or transmit the resulting updated image 160 and/or the bounding box data 140 to another device, such as the remote device 198. In a particular embodiment, one or more of the cameras 1512 can be mounted to capture an interior scene including one or more other passengers of the vehicle 1502, such as to monitor children in a rear seat of the vehicle 1502. Additionally, or alternatively, one or more of the cameras 1512 can correspond to forward-facing cameras and/or rear-facing cameras that capture fields of view external to the vehicle 1502 in conjunction with autonomous or driver-assisted operation of the vehicle 1502.

FIG. 16 illustrates an example of a method 1600 of determining the location of one or more objects to be generated in an image. One or more operations of the method 1600 may be performed by at least one of the object location model 130, the one or more processors 116, the device 102, or the system 100 of FIG. 1, as an illustrative, non-limiting example.

The method 1600 includes, at block 1602, obtaining, at a device, an image of a scene. For example, the input image 122 of the scene 124 may be obtained from the input image source 120, such as via the image data 105 from the image sensor 104 or from the remote device 198.

The method 1600 includes, at block 1604, obtaining, at the device, an indication of a designated class of object to insert into the scene. For example, the indication 107 of the designated class 134 may be obtained from the input device 106.

The method 1600 includes, at block 1606, processing, at the device, the image to determine, based on the designated class and scene features of the scene, a bounding box location and bounding box dimensions for insertion of an object having the designated class into the scene. For example, object location model 130 processes the input image 122 to determine, based on the scene features 132, the bounding box data 140 including the location 142 and the dimensions 144 for insertion of the object 152 having the designated class 134 into the scene 124. In some embodiments, processing the image to determine the bounding box location and bounding box dimensions may include performing one or more of the operations described in the example 300 of FIG. 3, which may be performed in conjunction with an embodiment of the object location model 130 that includes the image processor 202 and the bounding box generator 240 of FIG. 2. In other embodiments, processing the image to determine the bounding box location and bounding box dimensions may include performing one or more of the operations described in the example 600 of FIG. 6, such as one or more of the operations included in the inference process 692, which may be performed in conjunction with an embodiment of the object location model 130 that includes the candidate bounding box generator 402 and the object location model 430 of FIG. 4.

The method 1600 includes, at block 1608, outputting, at the device, the bounding box location and the bounding box dimensions. For example, the object location model 130 outputs the bounding box data 140 including the location 142 and the dimensions 144, which may be stored at the memory 110, transmitted to the remote device 198, processed by the image editor 150 to generate the updated image 160, or a combination thereof.

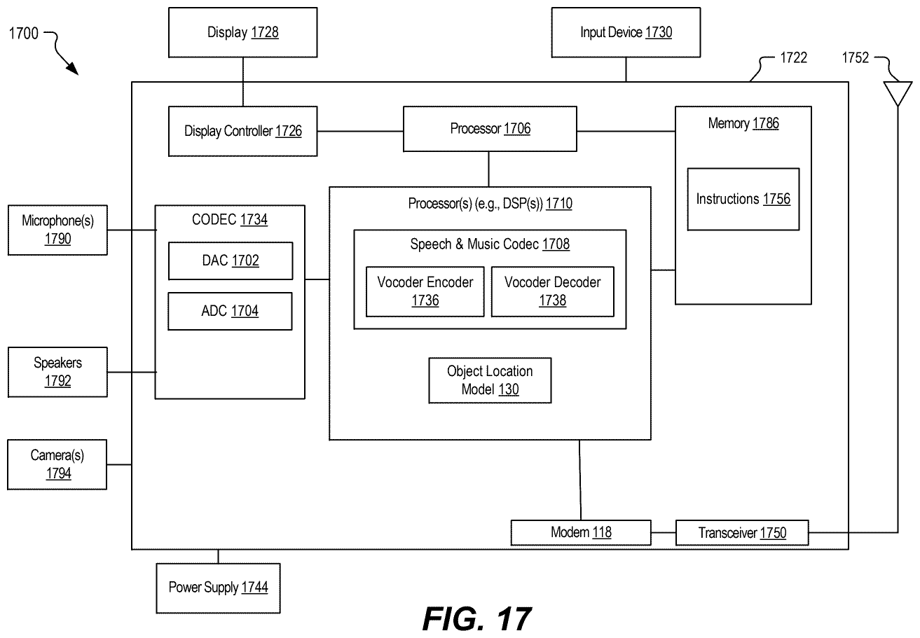

The method 1600 of FIG. 16 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1600 of FIG. 16 may be performed by a processor that executes instructions, such as described with reference to FIG. 17.

Referring to FIG. 17, a block diagram of a particular illustrative implementation of a device is depicted and generally designated 1700. In various implementations, the device 1700 may have more or fewer components than illustrated in FIG. 17. In an illustrative implementation, the device 1700 may correspond to the device 102 of FIG. 1. In an illustrative implementation, the device 1700 may perform one or more operations described with reference to FIGS. 1-16.

In a particular implementation, the device 1700 includes a processor 1706 (e.g., a CPU). The device 1700 may include one or more additional processors 1710 (e.g., one or more DSPs). In a particular implementation, the one or more processors 116 of FIG. 1 correspond to the processor 1706, the processors 1710, or a combination thereof. For example, the processors 1710 may include the object location model 130. The object location model 130 may include one or more of the components of one or more of the examples of FIGS. 1-6, or a combination thereof. The processors 1710 may further include one or more of the input image source 120 the image editor 150, the combiner 170, or the object detection model 180 of FIG. 1. The processors 1710 may also include a speech and music coder-decoder (CODEC) 1708. The speech and music CODEC 1708 may include a voice coder (“vocoder”) encoder 1736, a vocoder decoder 1738, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, CPUs, digital signal processors DSPs, neural processing units (NPUs), graphics processing units (GPUs), FPGAs, microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1700 may include a memory 1786 and a CODEC 1734. The memory 1786 may include instructions 1756 that are executable by the one or more additional processors 1710 (or the processor 1706) to implement the functionality described with reference to the processor 116 of FIG. 1. In a particular example, the memory 1786 corresponds to the memory 110 and the instructions 1756 correspond to the instructions 112 of FIG. 1. The device 1700 may include the modem 118 coupled, via a transceiver 1750, to an antenna 1752. The device 1700 may also include one or more cameras 1794, one or more of which may correspond to the image sensor 104 of FIG. 1.

The device 1700 may include a display 1728, such as the display device 190 of FIG. 1, coupled to a display controller 1726. One or more speakers 1792, one or more microphones 1790, or a combination thereof, may be coupled to the CODEC 1734. The CODEC 1734 may include a digital-to-analog converter (DAC) 1702 and an analog-to-digital converter (ADC) 1704. In a particular implementation, the CODEC 1734 may receive analog signals from the microphones 1790, convert the analog signals to digital signals using the ADC 1704, and send the digital signals to the speech and music codec 1708. In a particular implementation, the speech and music codec 1708 may provide digital signals to the CODEC 1734. The CODEC 1734 may convert the digital signals to analog signals using the DAC 1702 and may provide the analog signals to the speakers 1792.

In a particular implementation, the device 1700 may be included in a system-in-package or system-on-chip device 1722. In a particular implementation, the memory 1786, the processor 1706, the processors 1710, the display controller 1726, the CODEC 1734, and the modem 118 are included in a system-in-package or system-on-chip device 1722. In a particular implementation, an input device 1730 (e.g., a keyboard, a touchscreen, or a pointing device that corresponds to the input device 106 of FIG. 1) and a power supply 1744 are coupled to the system-in-package or system-on-chip device 1722. Moreover, in a particular implementation, as illustrated in FIG. 17, the cameras 1794, the display 1728, the input device 1730, the speakers 1792, the microphones 1790, the antenna 1752, and the power supply 1744 are external to the system-in-package or system-on-chip device 1722. In a particular implementation, each of the cameras 1794, the display 1728, the input device 1730, the speakers 1792, the microphones 1790, the antenna 1752, and the power supply 1744 may be coupled to a component of the system-in-package or system-on-chip device 1722, such as an interface or a controller.

The device 1700 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a vehicle, a computing device, a communication device, an internet-of-things (IoT) device, a virtual reality (VR) device, a base station, a mobile device, or any combination thereof.

In conjunction with the described techniques, an apparatus includes means for obtaining an image of a scene. In an example, the means for obtaining the image of the scene can include the input image source 120, the image sensor 104, the modem 118, the object location model 130 executed by the one or more processors 116, the one or more processors 116, the device 102, the system 100, one or more other circuits or devices to obtain an image of a scene, or a combination thereof.

The apparatus also includes means for obtaining an indication of a designated class of object to insert into the scene. In an example, the means for obtaining the indication of a designated class of object to insert into the scene can include the input device 106, the modem 118, the object location model 130 executed by the one or more processors 116, the one or more processors 116, the device 102, the system 100, one or more other circuits or devices configured to obtain an indication of a designated class of object to insert into the scene, or a combination thereof.

The apparatus also includes means for processing the image to determine, based on the designated class and scene features of the scene, a bounding box location and bounding box dimensions for insertion of an object having the designated class into the scene. In an example, the means for processing the image to determine, based on the designated class and scene features of the scene, a bounding box location and bounding box dimensions for insertion of an object having the designated class into the scene can include the one or more processors 116, the object location model 130 executed by the one or more processors 116, the device 102, the system 100, the image processor 202, the bounding box generator 240, the candidate bounding box generator 402, the object location model 430 executed by the one or more processors 116, one or more other circuits or devices configured to process the image to determine, based on the designated class and scene features of the scene, a bounding box location and bounding box dimensions for insertion of an object having the designated class into the scene, or a combination thereof.

The apparatus also includes means for outputting the bounding box location and the bounding box dimensions. In an example, the means for outputting the bounding box location and the bounding box dimensions can include the one or more processors 116, object location model 130 executed by the one or more processors 116, the modem 118, the display device 190, the device 102, the system 100, the bounding box generator 240, the object location model 430 executed by the one or more processors 116, one or more other circuits or devices configured to output the bounding box location and the bounding box dimensions, or a combination thereof.

In some implementations, a non-transitory computer-readable medium (e.g., a computer-readable storage device, such as the memory 110) includes instructions (e.g., the instructions 112) that, when executed by one or more processors (e.g., the one or more processors 116), cause the one or more processors to determine the location of one or more objects to be generated in an image, cause the one or more processors to perform operations corresponding to at least a portion of any of the techniques, operations, or methods described with reference to FIGS. 1-17, or any combination thereof. In an example, the instructions, when executed by the one or more processors, cause the one or more processors to obtain an image (e.g., the input image 122) of a scene (e.g., the scene 124). The instructions, when executed by the one or more processors, cause the one or more processors to obtain an indication (e.g., the indication 107) of a designated class (e.g., the designated class 134) of object to insert into the scene. The instructions, when executed by the one or more processors, cause the one or more processors to process the image to determine, based on the designated class and scene features (e.g., the scene features 132) of the scene, a bounding box location (e.g., the location 142) and bounding box dimensions (e.g., the dimensions 144) for insertion of an object (e.g., the object 152) having the designated class into the scene. The instructions, when executed by the one or more processors, also cause the one or more processors to output the bounding box location and the bounding box dimensions. Particular aspects of the disclosure are described below in the following sets of interrelated Examples:

According to Example 1, a device includes a memory configured to store an image of a scene; and one or more processors, coupled to the memory, wherein to determine the location of one or more objects to be generated in the image, the one or more processors are configured to: obtain the image of the scene; obtain an indication of a designated class of object to insert into the scene; process the image to determine, based on the designated class and scene features of the scene, a bounding box location and bounding box dimensions for insertion of an object having the designated class into the scene; and output the bounding box location and the bounding box dimensions.

Example 2 includes the device of Example 1, wherein the one or more processors are configured to generate an updated image that includes the object inserted at the bounding box location.

Example 3 includes the device of Example 1 or Example 2, wherein the one or more processors are configured to include the updated image in a training set of images to generate an augmented training set for an object detection model.

Example 4 includes the device of Example 3, wherein the one or more processors are configured to generate and include the updated image in the augmented training set to oversample one or more object classes in the augmented training set.

Example 5 includes the device of Example 3, wherein the one or more processors are configured to generate and include the updated image in the augmented training set to oversample one or more object depths in the augmented training set.

Example 6 includes the device of Example 3, wherein the one or more processors are configured to generate and include the updated image in the augmented training set to oversample one or more object classes and to oversample one or more object depths in the augmented training set.

Example 7 includes the device of any of Examples 3 to 6, wherein the object detection model corresponds to an automotive object detection model.

Example 8 includes the device of any of Examples 2 to 7, wherein the one or more processors are configured to generate the updated image in conjunction with an interactive image editor.

Example 9 includes the device of any of Examples 1 to 8, wherein the one or more processors are configured to: obtain distribution data that includes depth data and bounding box size data associated with one or more classes of objects, wherein the one or more classes of objects includes the designated class; sample the distribution data, based on the designated class, to obtain a depth of the object in the scene; obtain the bounding box location based on the depth and the scene features; and sample the distribution data, based on the depth and the designated class, to obtain a bounding box size, wherein the bounding box dimensions are based on the bounding box size.

Example 10 includes the device of Example 9, wherein the one or more processors are configured to: obtain a training set of images; process the training set of images to detect objects in the training set of images; determine object class data, depth data, and bounding box size data of the detected objects; and generate the distribution data based on the determined object class data, depth data, and bounding box size data.

Example 11 includes the device of any of Examples 1 to 10, wherein the one or more processors are configured to generate a semantic map based on the scene features, and wherein the bounding box location is determined based on the semantic map.

Example 12 includes the device of Example 11, wherein the training set of images includes street scenes, the semantic map indicates drivable space in the scene, and the bounding box location is determined to be within the drivable space.

Example 13 includes the device of any of Examples 1 to 12, wherein the one or more processors include an object location model that is configured to generate one or more predictions of a location of a masked object in an input scene; and the one or more processors are configured to determine the bounding box location and the bounding box dimensions based on an output of the object location model.

Example 14 includes the device of Example 13, wherein the one or more processors are configured to: obtain bounding box size and location data of each candidate bounding box of a plurality of candidate bounding boxes associated with the image; and process the bounding box size and location data in conjunction with the image at the object location model, wherein the output of the object location model indicates a prediction that a particular candidate bounding box of the plurality of candidate bounding boxes is a location of a masked object having the designated class in the scene.

Example 15 includes the device of Example 13 or Example 14, wherein the one or more processors are configured to: obtain a training set of images; process the training set of images to detect objects in the training set of images; determine object class data and bounding box size data of the detected objects; generate, for each image of the training set of images, mask data that corresponds to a bounding box of a detected object in the image and one or more additional distractor boxes; and train the object location model based on the training set of images and the mask data.

Example 16 includes the device of any of Examples 1 to 15 and further includes a display device coupled to the one or more processors, wherein the display device is configured to display an updated image that includes the object inserted at the bounding box location.

Example 17 includes the device of any of Examples 1 to 16 and further includes a camera coupled to the one or more processors, wherein the camera is configured to generate the image.

Example 18 includes the device of any of Examples 1 to 17 and further includes a modem coupled to the one or more processors, wherein the modem is configured to transmit the bounding box location and the bounding box dimensions.

According to Example 19, a method of determining the location of one or more objects to be generated in an image includes: obtaining, at a device, an image of a scene; obtaining, at the device, an indication of a designated class of object to insert into the scene; processing, at the device, the image to determine, based on the designated class and scene features of the scene, a bounding box location and bounding box dimensions for insertion of an object having the designated class into the scene; and outputting, at the device, the bounding box location and the bounding box dimensions.

Example 20 includes the method of Example 19 and further includes generating an updated image that includes the object inserted at the bounding box location.

Example 21 includes the method of Example 19 or Example 20 and further includes including the updated image in a training set of images to generate an augmented training set for an object detection model.

Example 22 includes the method of Example 21 and further includes generating and including the updated image in the augmented training set to oversample one or more object classes in the augmented training set.

Example 23 includes the method of Example 21 and further includes generating and including the updated image in the augmented training set to oversample one or more object depths in the augmented training set.

Example 24 includes the method of Example 21 and further includes generating and including the updated image in the augmented training set to oversample one or more object classes and to oversample one or more object depths in the augmented training set.

Example 25 includes the method of any of Examples 21 to 24, wherein processing the image to determine the bounding box location and bounding box dimensions includes executing an automotive object detection model at one or more processors of the device.

Example 26 includes the method of any of Examples 20 to 25, and further includes generating the updated image in conjunction with an interactive image editor.

Example 27 includes the method of any of Examples 19 to 26 and further includes: obtaining distribution data that includes depth data and bounding box size data associated with one or more classes of objects, wherein the one or more classes of objects includes the designated class; sampling the distribution data, based on the designated class, to obtain a depth of the object in the scene; obtaining the bounding box location based on the depth and the scene features; and sampling the distribution data, based on the depth and the designated class, to obtain a bounding box size, wherein the bounding box dimensions are based on the bounding box size.

Example 28 includes the method of Example 27 and further includes: obtaining a training set of images; processing the training set of images to detect objects in the training set of images; determining object class data, depth data, and bounding box size data of the detected objects; and generating the distribution data based on the determined object class data, depth data, and bounding box size data.

Example 29 includes the method of Example 28 and further includes: generating a semantic map based on the scene features, and wherein the bounding box location is determined based on the semantic map.

Example 30 includes the method of Example 29, wherein the training set of images includes street scenes, the semantic map indicates drivable space in the scene, and the bounding box location is determined to be within the drivable space.

Example 31 includes the method of any of Examples 19 to 30, and further includes: generating, at an object location model, one or more predictions of a location of a masked object in an input scene; and determining the bounding box location and the bounding box dimensions based on an output of the object location model.

Example 32 includes the method of Example 31 and further includes: obtaining bounding box size and location data of each candidate bounding box of a plurality of candidate bounding boxes associated with the image; and processing the bounding box size and location data in conjunction with the image at the object location model, wherein the output of the object location model indicates a prediction that a particular candidate bounding box of the plurality of candidate bounding boxes is a location of a masked object having the designated class in the scene.

Example 33 includes the method of Example 31 and further includes: obtaining a training set of images; processing the training set of images to detect objects in the training set of images; determining object class data and bounding box size data of the detected objects; generating, for each image of the training set of images, mask data that corresponds to a bounding box of a detected object in the image and one or more additional distractor boxes; and training the object location model based on the training set of images and the mask data.

Example 34 includes the method of any of Examples 19 to 33 and further includes displaying an updated image that includes the object inserted at the bounding box location.

Example 35 includes the method of any of Examples 19 to 34 and further includes generating the image.

Example 36 includes the method of any of Examples 19 to 35 and further includes transmitting the bounding box location and the bounding box dimensions.

According to Example 37, a device includes: a memory configured to store instructions; and a processor configured to execute the instructions to perform the method of any of Examples 19 to 35.

According to Example 38, a non-transitory computer-readable medium stores instructions that, when executed by a processor, cause the processor to perform the method of any of Examples 19 to 35.

According to Example 39, an apparatus includes means for carrying out the method of any of Examples 19 to 35.

According to Example 40, a non-transitory computer-readable medium comprises instructions that, when executed by one or more processors to determine the location of one or more objects to be generated in an image, cause the one or more processors to: obtain an image of a scene; obtain an indication of a designated class of object to insert into the scene; process the image to determine, based on the designated class and scene features of the scene, a bounding box location and bounding box dimensions for insertion of an object having the designated class into the scene; and output the bounding box location and the bounding box dimensions.

According to Example 41, an apparatus for determining the location of one or more objects to be generated in an image includes: means for obtaining an image of a scene; means for obtaining an indication of a designated class of object to insert into the scene; means for processing the image to determine, based on the designated class and scene features of the scene, a bounding box location and bounding box dimensions for insertion of an object having the designated class into the scene; and means for outputting the bounding box location and the bounding box dimensions.

Those of skill would further appreciate that the various illustrative logical blocks, configurations, circuits, and algorithm steps described in connection with the implementations disclosed herein may be implemented as electronic hardware, computer software executed by a processing device such as a hardware processor, or combinations of both. Various illustrative components, blocks, configurations, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary memory device is coupled to the processor such that the processor can read data from, and write data to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A device comprising:
a memory configured to store an image of a scene; and
one or more processors, coupled to the memory, wherein to determine the location of one or more objects to be generated in the image, the one or more processors are configured to:
obtain the image of the scene;
obtain an indication of a designated class of object to insert into the scene;
process the image to determine, based on the designated class and scene features of the scene, a bounding box location and bounding box dimensions for insertion of an object having the designated class into the scene; and
output the bounding box location and the bounding box dimensions.

2. The device of claim 1, wherein the one or more processors are configured to generate an updated image that includes the object inserted at the bounding box location.

3. The device of claim 2, wherein the one or more processors are configured to include the updated image in a training set of images to generate an augmented training set for an object detection model.

4. The device of claim 3, wherein the one or more processors are configured to generate and include the updated image in the augmented training set to oversample one or more object classes in the augmented training set.

5. The device of claim 3, wherein the one or more processors are configured to generate and include the updated image in the augmented training set to oversample one or more object depths in the augmented training set.

6. The device of claim 3, wherein the one or more processors are configured to generate and include the updated image in the augmented training set to oversample one or more object classes and to oversample one or more object depths in the augmented training set.

7. The device of claim 3, wherein the object detection model corresponds to an automotive object detection model.

8. The device of claim 2, wherein the one or more processors are configured to generate the updated image in conjunction with an interactive image editor.

9. The device of claim 1, wherein the one or more processors are configured to:
obtain distribution data that includes depth data and bounding box size data associated with one or more classes of objects, wherein the one or more classes of objects includes the designated class;
sample the distribution data, based on the designated class, to obtain a depth of the object in the scene;
obtain the bounding box location based on the depth and the scene features; and
sample the distribution data, based on the depth and the designated class, to obtain a bounding box size, wherein the bounding box dimensions are based on the bounding box size.

10. The device of claim 9, wherein the one or more processors are configured to:
obtain a training set of images;
process the training set of images to detect objects in the training set of images;
determine object class data, depth data, and bounding box size data of the detected objects; and
generate the distribution data based on the determined object class data, depth data, and bounding box size data.

11. The device of claim 10 wherein the one or more processors are configured to generate a semantic map based on the scene features, and wherein the bounding box location is determined based on the semantic map.

12. The device of claim 11, wherein the training set of images includes street scenes, the semantic map indicates drivable space in the scene, and the bounding box location is determined to be within the drivable space.

13. The device of claim 1, wherein:
the one or more processors include an object location model that is configured to generate one or more predictions of a location of a masked object in an input scene; and
the one or more processors are configured to determine the bounding box location and the bounding box dimensions based on an output of the object location model.

14. The device of claim 13, wherein the one or more processors are configured to:
obtain bounding box size and location data of each candidate bounding box of a plurality of candidate bounding boxes associated with the image; and
process the bounding box size and location data in conjunction with the image at the object location model, wherein the output of the object location model indicates a prediction that a particular candidate bounding box of the plurality of candidate bounding boxes is a location of a masked object having the designated class in the scene.

15. The device of claim 13, wherein the one or more processors are configured to:
obtain a training set of images;
process the training set of images to detect objects in the training set of images;
determine object class data and bounding box size data of the detected objects;
generate, for each image of the training set of images, mask data that corresponds to a bounding box of a detected object in the image and one or more additional distractor boxes; and
train the object location model based on the training set of images and the mask data.

16. The device of claim 1, further comprising a display device coupled to the one or more processors, wherein the display device is configured to display an updated image that includes the object inserted at the bounding box location.

17. The device of claim 1, further comprising a camera coupled to the one or more processors, wherein the camera is configured to generate the image.

18. The device of claim 1, further comprising a modem coupled to the one or more processors, wherein the modem is configured to transmit the bounding box location and the bounding box dimensions.

19. A method of determining the location of one or more objects to be generated in an image, comprising:
obtaining, at a device, an image of a scene;
obtaining, at the device, an indication of a designated class of object to insert into the scene;
processing, at the device, the image to determine, based on the designated class and scene features of the scene, a bounding box location and bounding box dimensions for insertion of an object having the designated class into the scene; and
outputting, at the device, the bounding box location and the bounding box dimensions.

20. A non-transitory computer-readable medium comprising instructions that, when executed by one or more processors to determine the location of one or more objects to be generated in an image, cause the one or more processors to:
obtain an image of a scene;
obtain an indication of a designated class of object to insert into the scene;
process the image to determine, based on the designated class and scene features of the scene, a bounding box location and bounding box dimensions for insertion of an object having the designated class into the scene; and
output the bounding box location and the bounding box dimensions.
